(19) United States
(12) Patent Application Publication
(10) Pub. No.: US 2009/0211238 A1
(43) Pub. Date: Aug. 27, 2009

(54) Fluid Control Device And Method For The Production Thereof

(75) Inventors: Günther Baldauf, Kernen (DE); Andreas Tschürtz, Essingen (DE); Theo Paulus, Xanten (DE)

Correspondence Address: THE OLLILA LAW GROUP LLC, 2060 BROADWAY, SUITE 300, BOULDER, CO, 80302, US

(73) Assignee: NORGREN GMBH, Fellbach (DE)

(21) Appl. No.: 11/920,515

(22) PCT Filed: May 10, 2006
(86) PCT No.: PCT/DE2006/000805

§ 371 Date: Feb. 20, 2009

(30) Foreign Application Priority Data
May 19, 2005 (DE) 10 2005 023 791.6

(51) Int. Cl. F16D 31/00; B23K 26/00

(52) U.S. Cl. 60/325; 219/121.85

(57) ABSTRACT

The invention relates to a fluid control device comprising at least one fluid actuator, such as pistons, membranes, disks, base bodies comprising combinations thereof or similar and at least one cover element. Control/supply channels, which are fluidcally connected to fluid channels which are arranged in the base body, are arranged in the base body and/or in the cover element. The control/supply channels are defined between the base body and the at least one cover element by means of welding joints which are produced by laser welding.

The present invention relates to a fluid control device and a method for the production thereof as defined in the preambles of independent claims 1 and 3.

### PRIOR ART

A control device for a piston/cylinder unit has been disclosed for example by EP 0 316 500 A1. The control described by that publication uses an intermediate plate, which is mechanically connected with the cylinder and which is provided with passage openings extending from one to the other of its surfaces thereby connecting the discharge opening of the valve with the spaces of the cylinder. Such an intermediate plate permits different switching arrangements to be realized.

A fluid connection between a valve block and a consumer, comprising at least one double-acting fluid motor, has been further known from DE 29 33 704 A1. That solution likewise uses a sealing plate provided with openings, functioning as control channels, which extend in the plane of the plate for connecting different connection openings of a valve block housing and of a consumer housing in different working positions. Fluidic control devices, realized for example by pneumatic valves or pneumatically operated valves, comprise different pneumatic units. In many cases, a so-called main stage or main valve is preceded by a primer or a valve known as pilot valve. Pneumatic pressure or control signals are supplied to the main stage which then changes its condition/switching position. The pilot valve or primer is connected for that purpose with the main stage via so-called control or signal lines/channels. The primer circuit, just as the main stage, are supplied via fluidic, especially pneumatic lines or volumes. Both the control channels and the supply lines, hereinafter shortly referred to as fluid channels, are realized by bores or grooves formed in the cover element and/or the base body, which are sealed using sealing elements such as grid seals, for example. The pre-fabricated grid seals permit only a limited number of variations of the control channels to be realized. In addition, the necessary high number of seals not only makes the arrangement prone to failure, but also requires high assembly/production and/or handling input thereby causing correspondingly high costs. In the case of multiple valve arrangements, known for example as valve islands, a great number of seals is required due to the great number of interfaces, which requirement leads to especially high costs. The need to achieve a certain compressive force per unit area, for pre-stressing the sealing elements, further leads to a great number of screws and threads and, as a result thereof, to considerable assembly costs. Pre-stressing is required because grid seals, and simple o-rings as well, need high pre-stressing forces to guarantee pressure tightness.

Now, it is the object of the present invention to improve a fluid control device, for example a pneumatic or pneumatically operated valve, and a method for production thereof, so that the before-mentioned problems are remedied and the most diverse control channel arrangements can be realized with low assembly input and, consequently, at low cost. Especially, optimum sealing of the control channels is to be simultaneously achieved.

### ADVANTAGES OF THE INVENTION

That object is achieved by a fluid control device, and a method for production thereof, having the features defined in claims 1 and 3.

Advantageous embodiments and further developments of the invention are the subject-matter of the dependent claims that refer back to those claims.

It is the basic idea of the invention to define and seal the control channels by welding seams made by laser welding. For, a welding seam achieves optimum hermetic sealing of the control channels without the any need for grid seals. Further, the most diverse forms of control and supply channels can be realized by laser welding. This also permits the switching volumes, which serve to set different switching times, to be changed or varied in an easy and simple way. Further, it is a particular advantage that providing the welding seams does away with the need for additional cutting operations. A decisive advantage is further seen in the fact that the production process lends itself to automation.

Advantageously, the welding seams not only serve to seal the control/supply channels, but also serve as means for mounting the cover element on the base body. Mounting the cover element on the base body by welding joints avoids the need for additional mounting elements, for example in the form of screws or clamping elements, or the like, which are used in the known control devices for pre-stressing the grid seals, O-rings, or the like, needed in the known solutions. This also considerably reduces the mounting expense. And the long-time effect of the seals is also substantially improved, compared with grid seals, O-rings, or the like, as welding joints will practically not wear, and will therefore achieve hermetical sealing over very long periods of time.

Preferably, the cover element consists of a plastic material suitable for transmission of the laser beams.

Advantageously, the laser beam is focused in such a way that its focus comes to lie in the area of channel edges. For producing the welding joints, the laser beam is moved along the channel edges, preferably in an automated way.

In order to obtain different “programming” of the control/supply line, the control/supply channels and/or the fluid channels may be provided with selectively removable fluid blocking means. Selective removal can be effected in this case by breaking such blocking means off at rupture joints, by piercing, drilling or fusing, by the use of exchangeable inserts in the plastic mold used for producing the base body/cover element, or the like. If fusing is selected, this preferably is effected by the same laser beam that is used for producing the welding joints for sealing the control/supply channels.

### DRAWING

Further advantages and features of the invention will be apparent from the description that follows and from the illustrations of certain embodiments of the invention.

In the drawing:

FIG. 1a, b shows a top view and a sectional side view of a fluid control device using the invention;

FIG. 2 shows a top view of a base body of the fluid control device illustrated in FIG. 1;

FIG. 3a shows one embodiment of a cover element of a fluid control device using the invention;

FIG. 3b shows another embodiment of a cover element of a fluid control device using the invention;

FIG. 4 shows a section along line IV-IV of the base body illustrated in FIG. 2; and

FIG. 5 shows a section along line V-V of the base body illustrated in FIG. 2.

### DESCRIPTION OF THE EMBODIMENTS

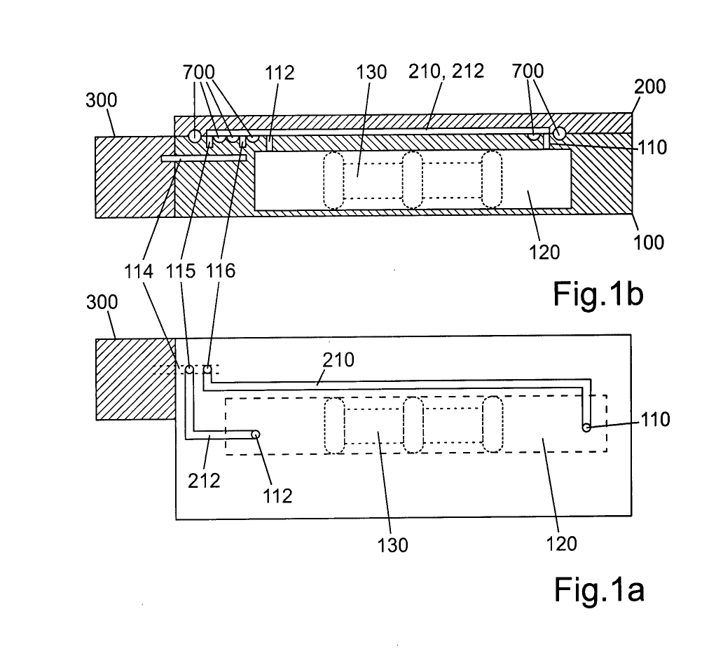

A fluid control device in the form of a pneumatic valve, illustrated in FIG. 1a, b, comprises a base body 100 with a cover element 200 mounted on it. Control/supply channels 210, 212, being connected with the control/supply channels 110, 112, are provided in the cover element 200 or in the base body 100. A cylinder space 120, in which a piston or a disk 130, or a membrane or a combination of those elements is movably guided, is arranged in the base body, for example.

The fluid control device may be preceded by what is known as a pilot valve or a precontrol 300, which is arranged for being selectively connected with the control/supply channels 210, 212, via fluid channels 114, 115, 116. Selective connection can be realized, as illustrated in FIG. 1b, by drilling, breaking open or piercing certain fluid blocking means in the form of barriers, arranged between the channel 114 and the channels 115, 116. It should be noted in this connection that instead of being arranged in the cover element 200, the control channels 210, 212 may also be arranged in the surface of the base body 100 facing the cover element 200, or in part in the surface of the base body 100 and in part in the cover element 200. The control channels 210, 212 are defined by welding joints 700 provided in the area of the channel edges.

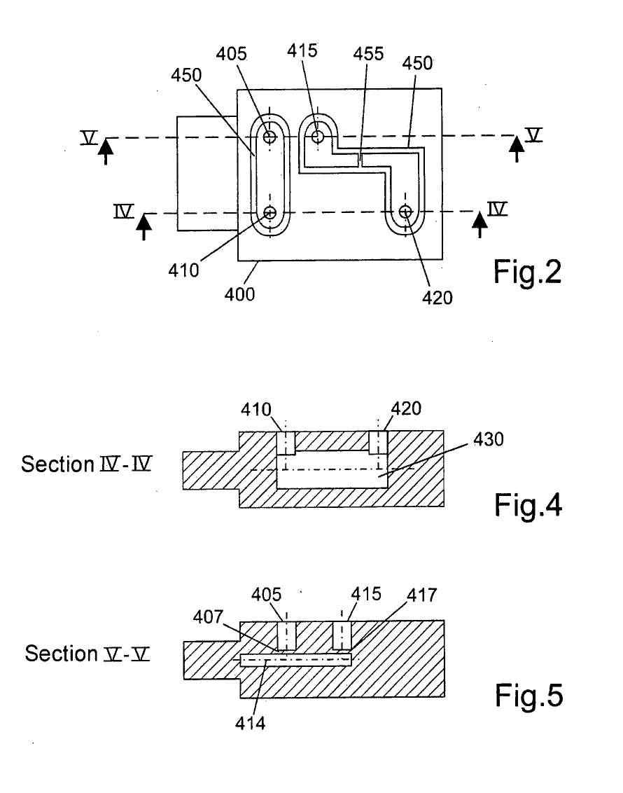

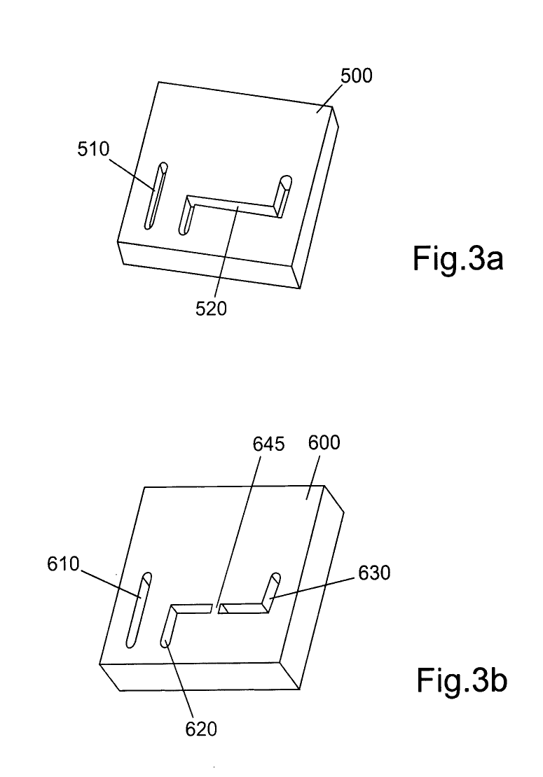

Another embodiment of a base body 400, made from a plastic material and comprising bores 405, 410, 415 and 420 intended to ensure the necessary pressure supply, is illustrated in FIG. 2. The bores 410, 420 terminate in a cylinder space 430 (FIG. 4) while the bores 405, 415 open into a control channel 414—as has been described before—after fluid blocking means in the form of barriers 407, 409 have been broken off or drilled open. As can be seen in FIG. 2, the base body 400 comprises webs 450 that define the control channels to be realized. A cover element 500 illustrated in FIG. 3a, or a cover element 600 illustrated in FIG. 3b, is placed on the base body 400 in such a way that the cover element 500, 600 illustrated in FIGS. 3a and 3b, respectively, comes to lie on the base body 400 in a position turned by 180°.

The cover elements 500, 600 are produced from a plastic material that is permeable to laser beams so that a laser beam of the kind used for laser welding can reach the webs 450 through the cover element 500, 600. The laser beam is focused to the area of the webs 450 so that the webs 450 will fuse. Heating-up the webs may be achieved on the one hand by such focusing and, on the other hand, by absorption at the base body 400. In that latter case, the base body 400 is impermeable to the laser beam so that the web will be fused by the laser beam hitting the web, and the reflection thereby produced. The pressure simultaneously exerted on the cover element 500, 600 at the same time acts to transmit the heat to the cover element 500, 600 to cause partial heating-up of the latter. Such heating-up and the contact pressure cause the base body 400 and the cover element 500, 600 to bond one to the other. The welding joint produced in this way seals the channels 510, 520 and 610, 620, 630, respectively, in the cover elements 500, 600 and simultaneous fixes the cover element 500, 600 on the base body 400. Instead of making the cover element 500, 600 permeable and the base body 400 impermeably to the laser beam, it is also possible to make the base body 400 permeable and the cover element 500, 600 impermeable to the laser beam.

In order to realize different control channel arrangements, a web 455 may be provided in the area of the control channel 620, 630 which is to be formed later—as illustrated in FIG. 2 and FIG. 3b. Similarly, the cover element 600 comprises a fluid blocking means 645 in the form of a wall. That wall can be provided with rupture joints and can be removed by piercing, breaking off, or the like, so that a single continuous channel is formed from the channels 620, 630. In case the fluid barrier 645 is not broken off, a welding joint will form also in the area of the web 455 so that the channels 620, 630 will be separated one from the other whereby a different control arrangement is realized for the control device. Such removal of fluid blocking means can be understood as “programming”. It is thereby possible to connect or to separate both control channels and supply channels. In this way, the most different control arrangements, such as 3/2-way valves or 5/3-way valves, can be realized using the same base bodies and the same cover elements. This leads to a considerably lower number of parts and tools needed for production of the base bodies and of the cover elements and, accordingly, to low-cost production of such control devices.

1-9. (canceled)

10. Pneumatic control device comprising at least one base body (100; 400), having at least one pneumatic actuator, such as pistons (130), membranes, disks, combinations thereof, or the like, and at least one cover element (200; 500; 600), where control/supply channels (210, 212; 510, 520; 610, 620, 630), being in fluid communication with fluid channels (110, 112; 405, 410, 415, 420) arranged in the base body (100; 400), are arranged in the base body (100; 400) and/or the at least one cover element (200; 500; 600), wherein the control/supply channels (210, 2112; 510, 520; 610, 620, 630) are sealed by welding joints (700) produced by laser welding between the base body (100; 400) and the at least one cover element (100; 500; 600).

11. The pneumatic control device as defined in claim 10, wherein the at least one cover element (200; 500; 600) is fixed on the base body (100; 400) by the welding joints (700).

12. Method for the production of a pneumatic control device comprising at least one base body (100; 400), having at least one fluid actuator, such as pistons (130)m membranes, disks, combinations thereof, or the like, and at least one cover element (200; 500; 600), where control/supply channels (210, 212; 510, 520; 610, 620, 630), being in fluid communication with the fluid channels (110, 112; 405, 410, 415, 420) arranged in the base body (100; 400), are arranged in the base body (100; 400) and/or the at least one cover element (200; 500; 600), wherein the control/supply channels (210, 212; 510, 520; 610, 620, 630) are sealed in the area of the channel edges by application of a welding joint (700) produced by welding between the base body (100; 400) and the at least one cover element (200; 500; 600).

13. The method as defined in claim 12, wherein the at least one cover element (200; 500; 600) is fixed on the base body (100; 400) by the welding joints (700).

14. The method as defined in claim 12, wherein that the base body (100; 400) or the at least one cover element (200; 500; 600) consists of a plastic material suitable for transmission of the laser beam.

15. The method as defined in claim 12, wherein the laser beam is focused in such a way that its focus comes to lie in the area of the channel edges.

16. The method as defined in claim 12, wherein the laser beam is moved along the channel edges.

17. The method as defined in claim 12, wherein the control/supply channels (210, 212; 510, 520; 60, 620, 630) and/or the fluid channels (110, 112; 405, 410, 415, 420) comprise selectively removable fluid blocking means (407, 409; 645).

18. The method as defined in claim 17, wherein removal of the fluid blocking means (407, 409; 645) is effected by breaking off and/or by piercing and/or by drilling and/or by fusing and/or by the use of exchangeable inserts in a plastic mold.
